(19) United States
(12) Patent Application Publication
(10) Pub. No.: US 2017/0321630 A1
(43) Pub. Date: Nov. 9, 2017

(54) EXTERNAL COMBUSTION ENGINE WITH SEQUENTIAL PISTON DRIVE

(71) Applicant: Seppo LAITINEN, Helsinki (FI)

(72) Inventor: Seppo LAITINEN, Helsinki (FI)

(21) Appl. No.: 15/330,921

(22) PCT Filed: Dec. 3, 2014
(86) PCT No.: PCT/FI2014/000036

§ 371 Date: Apr. 8, 2016

(30) Foreign Application Priority Data
Feb. 17, 2014 (FI) 20140044

(51) Int. Cl. F02G 1/044; F01B 7/16; F02G 1/05

(52) U.S. Cl. CPC F02G 1/044; F02G 1/05; F01B 7/16; F02G 2244/54

(57) ABSTRACT

Method and system for efficient energy recovery from heat source with external combustion engine. Invention include sequentially operating drive mechanism for power pistons and displacement pistons of gamma type Stirling engine, providing nearly ideal pistons operation sequence. Stirling engine is supplemented with working flow fluid control and separation member between working fluid reheater and rest of the engine during high pressure stage. Working fluid is circulated in flow control via one or more consecutive displacement cylinder/power cylinder stages before reheating. Control system is directing working fluid from inlet port to the first displacement cylinder, further to the first power cylinder and after expansion either to reheating or to the next displacement cylinder. Low temperature working fluid is finally directed back to the counter flow type reheater.

### TECHNICAL FIELD

The present invention is related to external combustion engines. More specifically a modified gamma type Stirling engine with working fluid flow control system and possibility to connect multiple units in consecutive row to circulate working fluid through the row before re-heating. Invention provides nearly ideal timing for operation of power pistons and displacement pistons resulting low temperature working fluid stream output to external re-heater for efficient heat source energy recovery. Power control response time is improved by use of mixing valve system and various temperature working fluid fractions for power input control and/or intermediate re-heating of working fluid for optimizing between shaft power/overall efficiency.

### BACKGROUND OF THE INVENTION

Present CHP units used for electric power generation are operating within typical temperature parameters as follows:
Flue gas temperature after burner 1250° C. Construction materials durability and ash softening with resulting heater surfaces scaling are limiting further increase of temperature.
Flue gas temperature after Stirling engine 820° C. Stirling engines working fluid average temperature is in range of 650-750° C. and considering the required temperature difference for heat flux from flue gas to working fluid, possibilities to cool down the flue gas any further without loss of engine power output, may not be possible.
Flue gas temperature after combustion air pre-heater 650° C.

With the parameters above, the present technology for electric power generation is recovering flue gas energy from 1250° C. down to 650° C. and rest of the energy is wasted, unless used for other purposes. Therefore, minimizing the temperature cap between flue gas and working fluid, as well as minimizing working fluid temperature used for flue gas cooling are essential in respect of shaft power efficiency.

Dead volume, like channels and internal volume of re-heater pipes should be minimized for their negative effect to engine shaft power output. However, the high heat flux required in re-heater in turn requires large surface area inside the re-heater pipes, that is conflicting requirement to keep dead volume in minimum. Compromises are inevitable in minimizing either dead volume or temperature difference between heat source and working fluid.

Ideal operation sequence for gamma type Stirling engine pistons is to keep displacement piston at cold end of cylinder during whole expansion period and to move it to the other end before beginning of power pistons return stroke and to keep it there until completion of stroke. Present gamma Stirling engines constructions are using crank drives/continuous movement of both pistons, resulting substantial loss of capacity in conversion of working fluid pressure to mechanical work.

Stirling engines power control has reputation to be slow, as proportion of heat energy in re-heater pipes and cylinder materials vs. power output is high, and there is no practical method available to speed up cooling of pipes and cylinders when power control down is required.

### BRIEF SUMMARY OF THE INVENTION

The present invention is directed to a method and system for an external combustion engine, consisting process stages and components known in gamma Stirling engine with additional working fluid flow diverter system, new pistons drive mechanism and improved power control methods. New working fluid flow diverter system is isolating re-heater system from rest of the engine while the cylinders where re-heater is connected are in over/sub-pressure stage.

Furthermore, diverter system is directing working fluid from first displacement cylinder to the first power cylinder and after expansion stage, further to the next consecutive displacement cylinder and so on, until to the re-heater exit port. While passing through multiple pressurizing/expansion stages, thermal energy in working fluids is converted to mechanical work (and losses) resulting low temperature working fluid stream to re-heater, where high heat flux and small temperature cap between working fluid and heat source is achieved by use of counter flow type heat exchanger.

Invention provides two improvements for power control response time. Low temperature working fluid can be directed back to first stage inlet without re-heating by use of multi-port control valve (FIG. 6 Valve D port C) resulting immediate heat energy feed reduction or overheated fluid fraction can be taken out from re-heater to give a boost for engine in case additional power is required. An other option is to replace manifold (FIG. 1 item 300) by Power control manifold (FIG. 7) and increase working fluid temperature at middle of the normal flow route.

New pistons drive mechanism is based on rotating profiled discs (FIG. 1 items 150-152) and wheels in contact to the profiled edge surface (FIG. 1 items 140-142). Disc profile is divided to main sectors and transition sectors between the main sectors. Main sectors quantity must be multiple of four. Main sectors are controlling piston positions and movements as follow (FIG. 3):
Sector 1 Piston stopped to upper position;
Sector 2 Piston is moving down with constant speed;
Sector 3 Piston stopped to lower position; and
Sector 4 Piston is moving up with constant speed.

Transition sectors are for acceleration and deceleration of pistons velocity with constant g-value. Displacement piston's drive profiled discs rotation is one quarter cycle ahead of power piston's drive profiled disc rotation. Pistons and drive mechanism moving parts and g-values are so selected that mass of displacement pistons and related auxiliaries and drive mechanism parts, moving in direction of stroke, multiplied by g-value of displacement piston drive equals to negative product of mass of power pistons and related auxiliaries and drive mechanism parts moving in direction of stroke multiplied by g-value of power piston drive. Center of gravity of displacement pistons, related auxiliaries and drive parts mass moving in stroke direction are located at the same line with center of gravity of power pistons, related auxiliaries and drive parts mass moving in stroke direction. As a result, accelerating and decelerating forces of the moving masses are compensating each others and kinetic energy of the decelerating mass is passed via main shaft to the accelerating mass. The present invention provide nearly ideal pistons operation sequence and no vibration caused by moving parts dynamics.

### BRIEF DESCRIPTION OF THE DRAWINGS

For a more complete understanding of the present invention, reference is now made to the following descriptions in conjunction with the accompanying drawings, in which:

FIG. 1 disclose one embodiment of the invention, where major entities related to the invention are illustrated at side view;

FIG. 2 is is a sectional presentation of one embodiment of the invention, where pistons drive profile discs and wheels are illustrated at end view;

FIG. 3 is a schematic presentation of the pistons drive discs and wheels, where location and range of sectors are shown in details and where outer end is profiled;

FIG. 4 is an alternative profiled surfaces location where face surface of the disc is profiled;

FIG. 5 is a presentation of the working fluid flow routes while power piston is moving up and while power piston is moving down;

FIG. 6 is a schematic diagram for an alternative embodiment of invention with two high pressure/expansion stages and diagrammatic presentation of power controls by use of multi-port control valve system;

FIG. 7 is a replacement for manifold (FIG. 1 item 300) to enable intermediate working fluid re-heating for power/efficiency optimizing; and

FIG. 8 is an alternative configuration of the invention illustrated at side view.

### DETAILED DESCRIPTION OF THE INVENTION

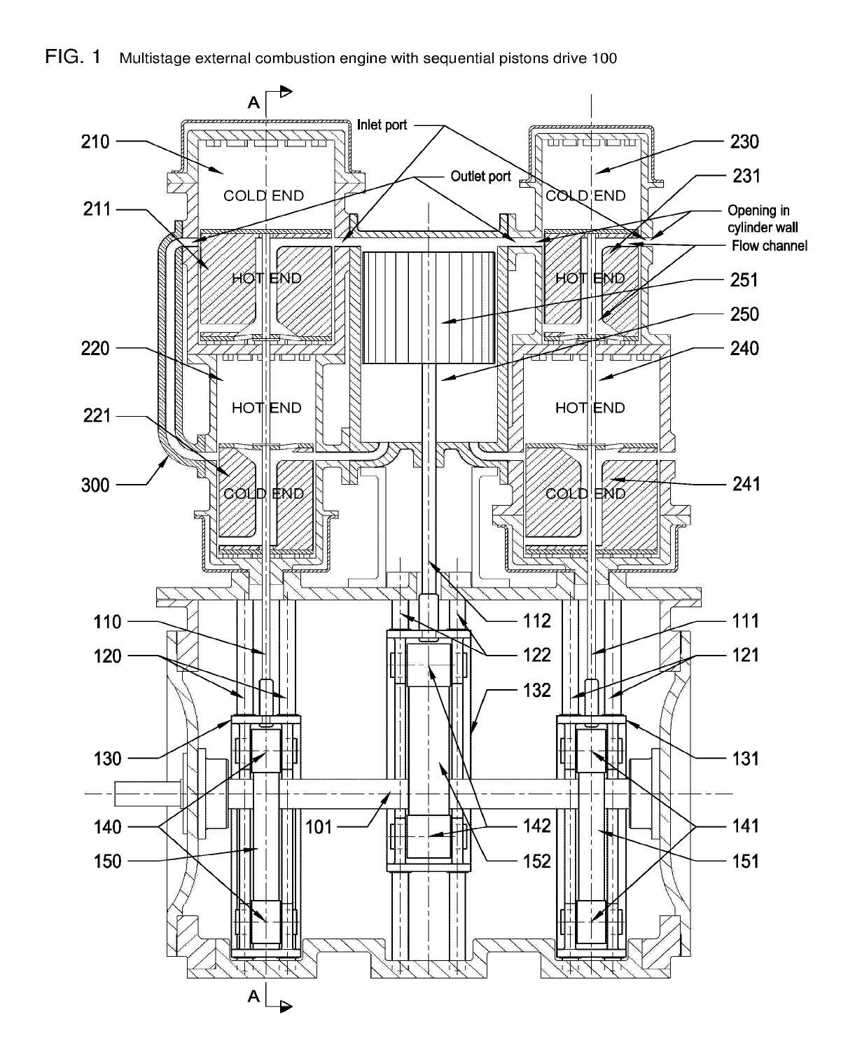

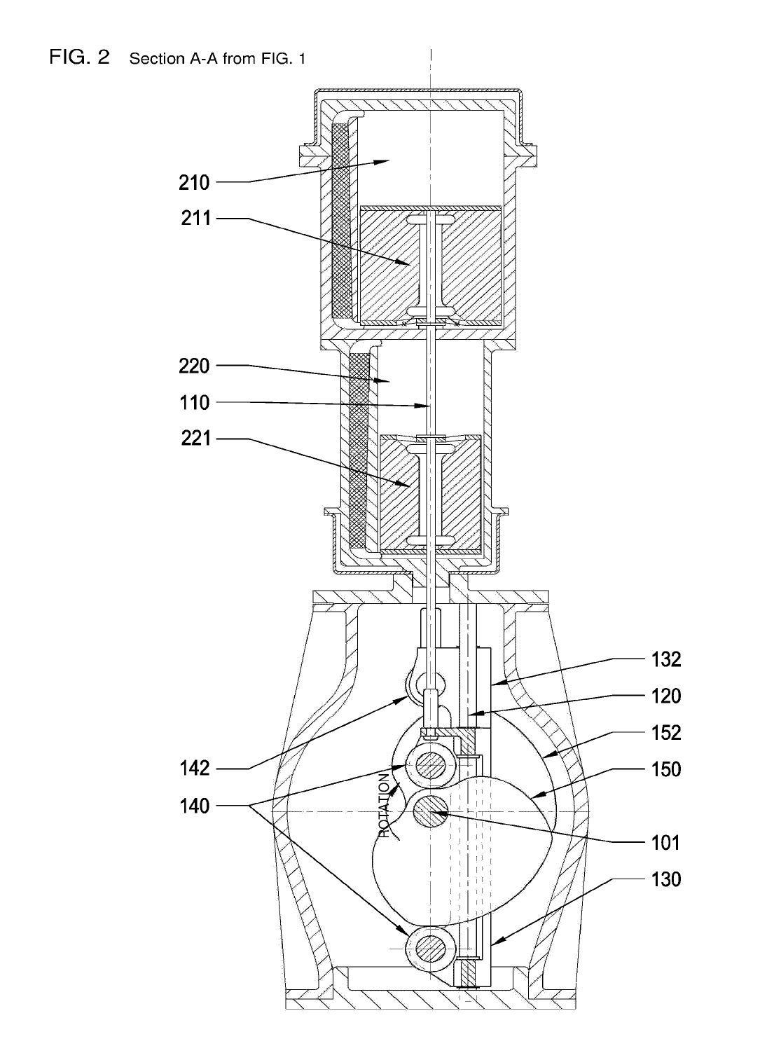

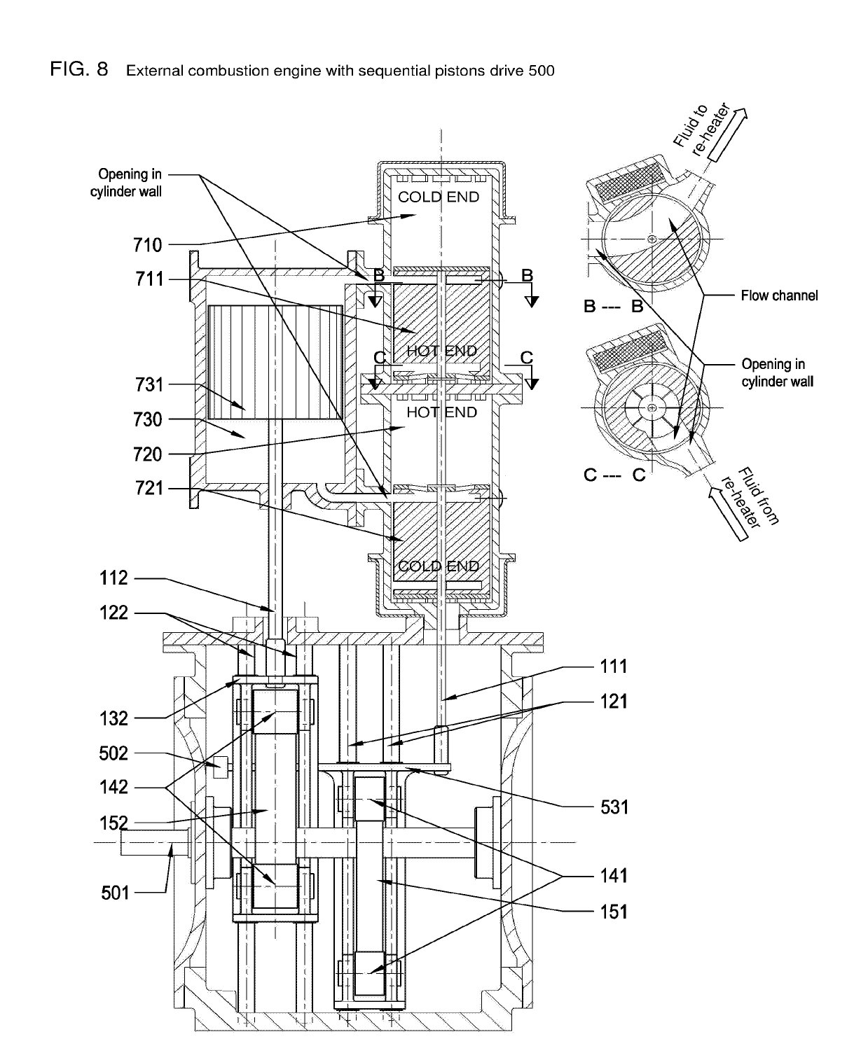

Two embodiments of the present invention Multistage external combustion engine with sequential pistons drive (100), are disclosed in FIG. 1, FIG. 8 and FIG. 2. Other configurations with different number and position of pressurizing cylinders (210, 220, 230, 240, 710 and 720), power cylinder (250 and 720), displacement piston drives (120, 130, 140, 150 and 121, 131, 141, 151) and power piston drive (122, 132, 142, 152 and 502, 531) are envisioned. Each pressurizing cylinder (210, 220, 230, 240 and 710, 720) include displacement piston (211, 221, 231, 241 and 231, 141 respectively) and regenerator (FIG. 2 at left side of cylinders). Displacement pistons are linked to displacement piston drives with piston rods (110, 111) and power piston is linked to power piston drive with piston rod (112). Power cylinder include power piston. Power pistons in FIG. 1 and FIG. 8 are of dual action type.

Pressurizing cylinders operation and thermodynamic principle are the same to the gamma type Stirling engine thermodynamic with additional channels in pistons and openings in cylinder wall used to divert working fluid flow in and out of the cylinder and further to the next cylinder or through re-heater. Displacement piston move to the cold end of the pressurizing cylinder is forcing working fluid through regenerator to the hot end of the cylinder. Working fluid is heating up while passing through regenerator, resulting increase of pressure inside the cylinder by semi-adiabatic process. Pressurized working fluid is directed through valve port to: Power cylinder, where adiabatic expansion is resulting partial conversion of working fluid PV (pressure* volume) potential to mechanical work and reduction of working fluid pressure and temperature; or to the next pressurizing cylinder (where displacement piston is at hot end of the cylinder) enabling increased pressure output from the same after displacement piston is moved to the cold end of the cylinder.

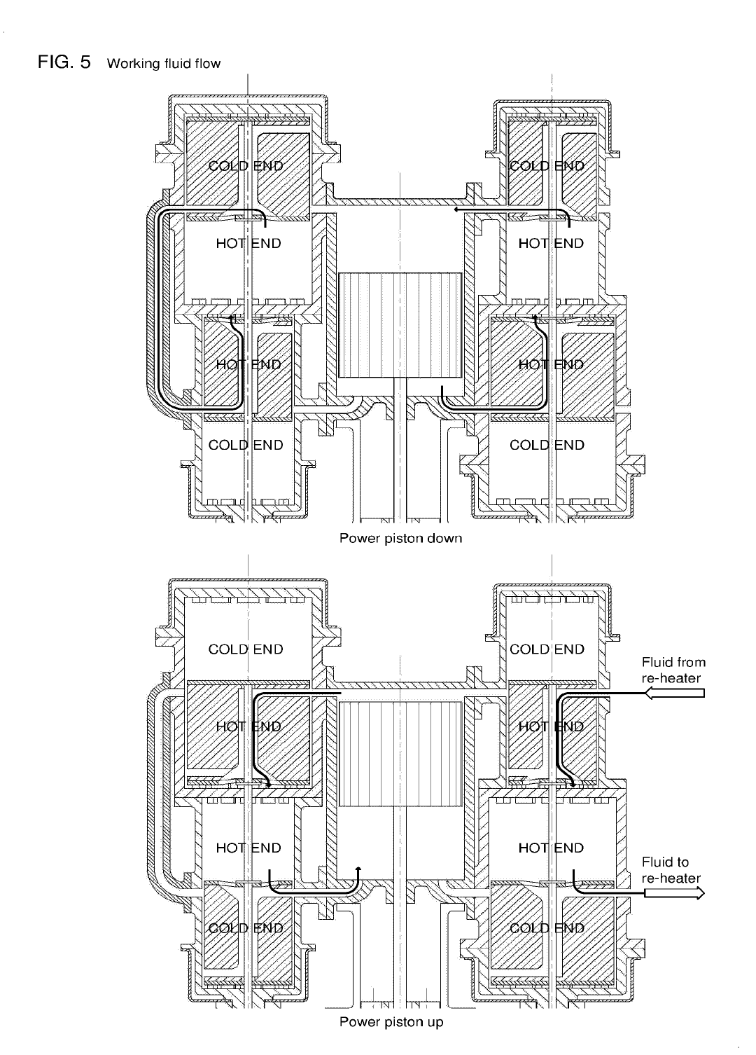

At one end of displacement piston stroke, one group of flow routes through piston channels and cylinder wall openings are closed and the other ones are open. At the other end of the piston stroke another group of flow routes are open and other ones are closed (FIG. 5). Near the end of power piston stroke piston velocity is decelerating to complete halt while displacement piston movement is simultaneously accelerating to full velocity. The same will take place in inverse order near the end of displacement piston stroke, where displacement piston will decelerating to complete halt and power piston stroke is instantaneously accelerating to full velocity.

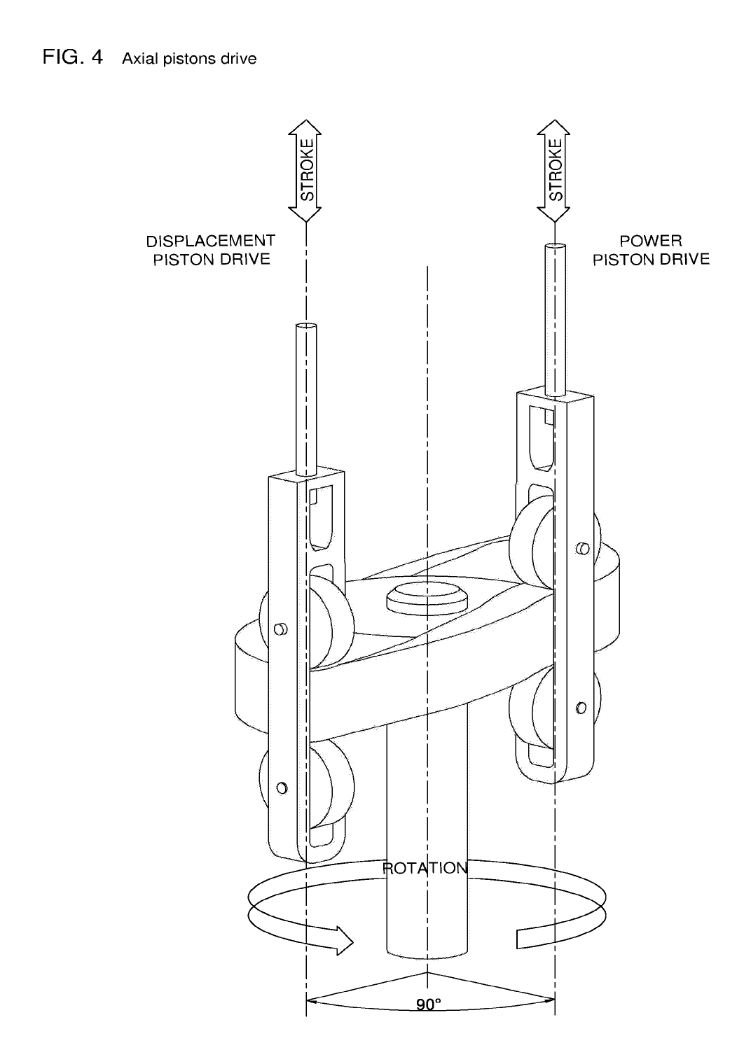

Each piston drive include radial type profiled disc (150, 151 and 152) or alternative axial type (FIG. 4), wheels in contact to the profiled surface, one or multiple wheel(s) located above and one or multiple below. Wheels are connected to piston drive frames (130, 131 132 and 531) with bearings. Piston drive frame movement and rotation is restricted by guide rails (120, 121 and 122) to allow movement in piston stroke direction only. Profiled discs are attached to the main shaft (101 and 501).

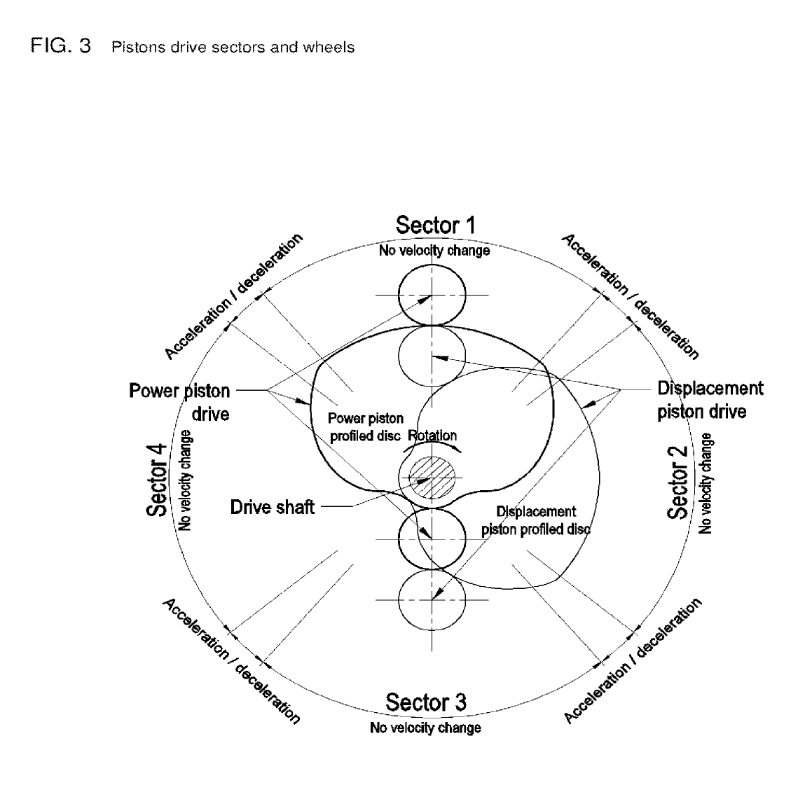

Profiled discs and wheels lay-out is presented in FIG. 3. Main sectors 1, 2, 3 and 4 are for pistons moving either with constant velocity, or halted to maximum or minimum stroke location. Acceleration/deceleration sectors are for simultaneous acceleration of displacement pistons and deceleration of power piston, or vice versa. Acceleration/deceleration sectors timings are set to match and g-force directions and size of displacement piston and power piston drives, pistons and related masses are opposite to each others in purpose to eliminate each others and thus avoid dynamic forces generated vibrations. Outside the acceleration/deceleration sectors, there is always either displacement pistons moving with constant speed and power piston not moving, or power piston moving with constant speed and displacement pistons not moving.

In addition to profiled discs with profiled surface located on outer surface of disc, all the above is valid for ring or recess in disc where profiled surface is located on inner surface of ring or recess.

Openings on cylindrical surface of pistons (211, 221, 131, 241 and 711, 721) and openings in cylinder walls are working as shut-off valves. Working fluid flow routes and directions of flows are shown in FIG. 5. Upper part of the drawing is for working fluid flows while power piston is moving downwards and lower part while power piston is moving upwards. Hot working fluid is coming in from re-heater to the connection marked as “Fluid from re-heater” and cooled down working fluid is directed back to the re-heater from connection marked as “Fluid to re-heater”.

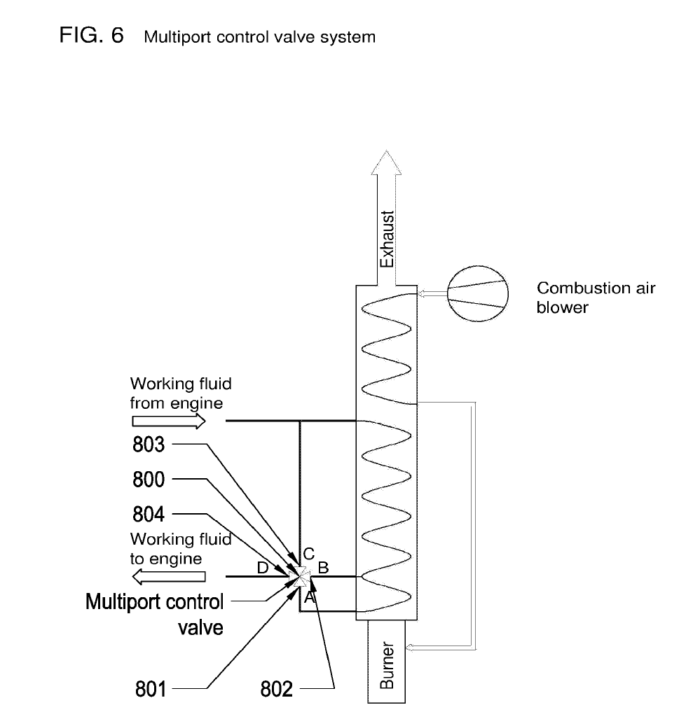

FIG. 6 disclose mixing valve system (D) used for power control. Counterflow type re-heater in the diagram has two outlets and one inlet. However, more outlet ports system is envisioned. Working fluid stream to mixing valve port (A) is used occasionally for rapid heating up of engine. During normal operation working fluid main stream is directed to mixing valve system port (B) and minor fraction to port (A) if temperature control so require. For rapid engine cooling down, low temperature working fluid is directed to mixing valve system port (C).

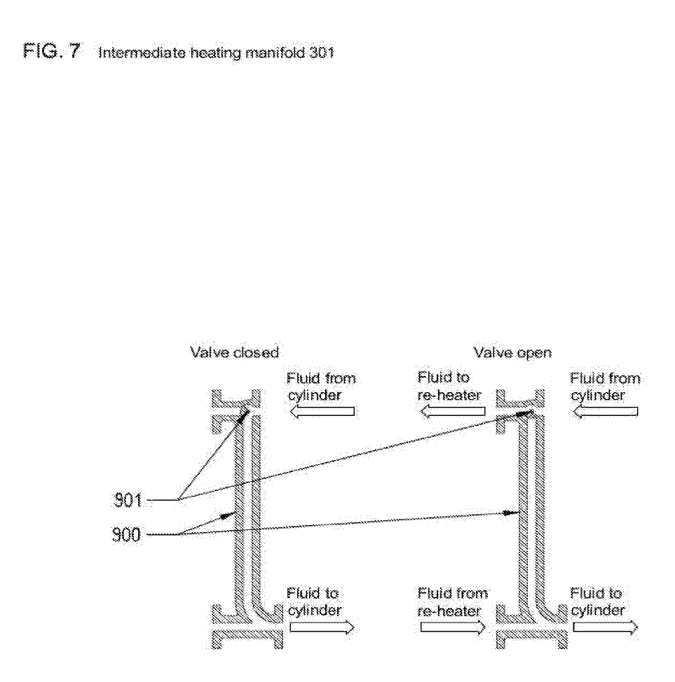

FIG. 7 disclose an alternative manifold to replace cylinders connection part (300). Manifold include 3-way valve and two additional connections. In fully closed position valve is directing all the working fluid from pressurizing cylinder 210 to pressurizing cylinder 220. In fully open position of valve all the working fluid is directed to re-heater and working fluid coming back from re-heater is directed to pressurizing cylinder 220. In valve partially open position, fraction of working fluid is directed to pressurizing cylinder 220 and all the rest to the re-heater, from where it is returned back and further to pressurizing cylinder 220. Fraction of working fluid directed to re-heater is heated up resulting shaft power increase and overall shaft power efficiency decrease. Control is used for rapid power increase and for short term periods when high shaft power is required.

In the configuration of invention disclosed in FIG. 1, there are two sets of consecutive operation sequences as follows:
1. 1st pressurizing cylinder, fluid inflow from heat source and outflow to 1st power cylinder.
2. 1st power cylinder, fluid inflow from 1st pressurizing cylinder and outflow to 2nd pressurizing cylinder.
3. 2nd pressurizing cylinder, fluid inflow from 1st power cylinder and outflow to heat source or to next pressurizing cylinder.

At the end of power piston down stroke (FIG. 5), the amount of working fluid mass inside the 2nd and 3rd pressurizing cylinder is directly proportional to volume/temperature quotient values of each hot end, cold end and dead volume. As most of the working fluid mass in 2nd pressurizing cylinder is in high temperature and most of working fluid mass in 3rd cylinder is in cold temperature, most of the working fluid mass will be in 3rd pressurizing cylinder at the end of pressurizing cylinder piston stroke. Moving the working fluid mass from 2nd pressurizing to 3rd pressurizing cylinder will reduce consumed energy needed for power piston return stroke and will compensate low temperature of the working fluid entering to second consecutive set of process stages.

All the operation descriptions above are applicable for use of invention as Stirling cooler, where cold end of the cylinders are used as coolant source and re-heater is used as a heat sink.

What is claimed is:

1. An engine unit embodiment based on modified gamma type Stirling engine (FIG. 1, FIG. 8) with additional working fluid flow control system by using Flow channels (FIG. 1, Flow channel and FIG. 8, Flow channel) in displacement pistons and openings in pressurizing cylinder walls (FIG. 1, Opening in cylinder wall and FIG. 8, Opening in cylinder wall) and sequentially operating pistons drive operating in sequences (FIG. 3, Sectors 1-4, Acceleration/deceleration), the invention characterized by: Flow channels in piston or pistons together with opening or openings in cylinder walls enabling/disabling working fluid flow; and alternating movements of displacement piston set and power piston set such that while one of the piston sets is moving with full velocity, the other one is halted at the end of piston stroke position.

2. Sequentially operating pistons drive system comprising: Piston drive frames with guide rails (FIG. 2 item 130); wheels (FIG. 2 item 10); and rotating members with profiled surfaces (FIG. 2 item 150 and FIG. 3 or FIG. 4 or profiled inner surface of ring or recess in any disc or object) attached on main shaft (FIG. 1 item 101 or FIG. 8 item 501); displacement piston rotating member rotation being one quarter of full round of sequences ahead of working piston rotating member rotation, characterized by shape of profiled surfaces being combination of: Main shaft rotation angle synchronized main sectors, producing together with contacting wheels and auxiliaries reciprocating, unidirectional and unchanging velocity movements and movements alternating such that while related piston or pistons are moving with full velocity the other piston or pistons are halted at end of stroke position; and transition sectors for simultaneous velocity acceleration of related piston or pistons and velocity deceleration of other piston or pistons.

3. Sequentially operating pistons drive of claim 2, wherein reciprocating parts induced dynamic forces appearing during pistons velocity change are eliminated by fitting dynamic forces to be opposite to each others, invention characterized by: Opposite directions of induced force vectors; dynamic force vectors are located on common line; and absolute force values of mass of piston(s) with related auxiliaries and components moving in direction of related stroke multiplied by related acceleration/deceleration values, are identical to each others.

4. Method for rapid heat flux control (FIG. 6) for engine units of claim 1, characterized by use of multiport control valve (FIG. 6 item 800) connected to different temperature working fluid sources to provide: Normal temperature working fluid (FIG. 6 item 802) for continuous full power run; overheated working fluid for rapid power increase (FIG. 6 item 801); low temperature working fluid for rapid power decrease (FIG. 6 item 803); and mixture of normal temperature and low temperature fluids (FIG. 6 item 802 and 803) for partial power run.

5. Engine unit (FIG. 1) wherein set of two pressurizing cylinders and one power cylinder are connected for serial mode operation, invention characterized by working fluid flow route for one set is starting from first pressurizing cylinder (230) inlet port (Inlet port), then continues to power cylinder (250) and is ending to second pressurizing cylinder (210) outlet port (Outlet port).

6. Method of power control of engine unit (FIG. 1) by connecting two sets of cylinders of claim 5 for serial mode operation with intermediate heating manifold (FIG. 7), invention characterized by pipe manifold (900) with three-way valve (901) connecting first and second set of cylinders and circulating all or part of working fluid stream via re-heating before entering to second set of cylinders.

7. Engine unit (FIG. 1) wherein method for heat to pressure conversion is implemented by connecting consecutive pressurizing cylinders (210, 211 and 220, 221) for serial mode operation, invention characterized by serially connected pressurizing cylinders, operating inversely to each others with open working fluid passage between the cylinders while hot space volume of the first cylinder is increasing or at maximum and cold space volume of the second cylinder is decreasing or at minimum.

8. An engine unit embodiment based on modified gamma type Stirling engine (FIG. 1, FIG. 8) wherein method to eliminate re-heater void volume effect during pressurizing phase is implemented by closing flow route from re-heater to pressurizing cylinder by using closing member (FIG. 1 Inlet port at 230 and 231, FIG. 8 Inlet port at 710 and 711), invention characterized by synchronously operating closing member in working fluid flow channel separating re-heater internal space and pressurizing cylinder internal space while displacement piston is moving towards pressurizing cylinder cold end or displacement piston is stand still at pressurizing cylinder cold end.

9. An engine unit embodiment based on modified gamma type Stirling engine (FIG. 1, FIG. 8) wherein multiple displacement cylinders (FIG. 1 211, 221, 231, 241; FIG. 8 711, 721) are linked to common piston rod (FIG. 1 110, 111; FIG. 8 111) and related pistons drive mechanism, invention characterized by multiple displacement cylinders linked to common piston rod and related piston drive mechanism.
